(19) United States
(12) Patent Application Publication
(10) Pub. No.: US 2024/0199896 A1
(43) Pub. Date: Jun. 20, 2024

(54) Radar-Compatible Plastic Part

(71) Applicant: Merck Patent GmbH, Darmstadt (DE)

(72) Inventors: Udo Gumsheimer, Darmstadt (DE); Kevin Kaiser, Darmstadt (DE)

(73) Assignee: Merck Patent GmbH, Darmstadt (DE)

(21) Appl. No.: 18/556,508

(22) PCT Filed: Apr. 25, 2022
(86) PCT No.: PCT/EP2022/060807

§ 371 Date: Oct. 20, 2023

(30) Foreign Application Priority Data
Apr. 26, 2021 (EP) 21170442.4

(51) Int. Cl. C09D 5/36; C08J 7/04; C09D 7/40; C09D 7/62

(52) U.S. Cl. CPC C09D 5/36; C08J 7/04; C09D 7/62; C09D 7/70; C08J 2367/02; C08J 2400/00

(57) ABSTRACT

A radar-compatible plastic part that has a surface provided with a colouring coating that is free from metal-effect pigments; a process for the production of a radar-compatible plastic part of this type; and the use thereof in vehicle construction. The radar-compatible, coated plastic part is suitable for use for cover parts of radar devices, omits conventional metal-effect pigments in its colouring coating, and has a silver-coloured metallic appearance, high hiding power, and a strong lightness flop, and at the same time, a good radar wave transparency.

The present invention relates to a radar-compatible plastic part which has a surface provided with a colouring coating that is free from metal-effect pigments, to a process for the production of a radar-compatible plastic part of this type, and to the use thereof, in particular in vehicle construction.

With the increase in vehicles that enable autonomous driving, it is necessary to integrate radar devices which enable both distance measurement to other vehicles or traffic obstacles and the measurement of the speed of other traffic participants into the corresponding automobile parts to a hitherto unimagined extent. Such radar devices are generally installed behind bumpers of vehicles in order not to adversely impair the visual appearance of the vehicle.

For many years, metallic paints, preferably silver-coloured metallic paints, have counted amongst the most popular vehicle paints, in particular for the private vehicle sector. However, these metallic paints represent a major challenge in relation to the optical design of cover parts for radar devices installed in the interior of such vehicles since the usual metallic paints, which contain aluminium-based metal-effect pigments, can reflect, attenuate or absorb the radar waves, which are usually in the frequency range 76-81 GHz, to such an extent that the use of previously customary metallic vehicle paints for cover parts of radar devices in vehicles would lead to an undesired reduction in the functionality of the radar devices.

There has therefore been no lack of attempts to provide solutions for the covering of vehicle radar devices that do not impair the visual appearance of the vehicles and enable good functionality of the installed radar devices.

Corresponding cover parts, which are designed, for example, as radiator grilles or company logos and have very substantially radar wave-transparent areas and metallised struts, often have layers of vapour-deposited metals, such as indium. Such components usually exhibit a chrome-like visual appearance.

However, coatings of this type are not suitable for vehicle parts which, although located in the beam path of a radar device, are intended to leave the observer with the visual impression of a conventional silver-coloured metallic paint. The difficulty here consists in achieving the strong lightness flop that is usual in the case of metallic paints containing metal pigments (clear change from light to dark on a change in the illumination or viewing angle), achieving the hiding power of metallic paints of this type to the greatest possible extent, and reducing the attenuation of radar waves to such an extent that the transmission of the radar waves is sufficient to be able to operate an installed radar device in a fully functional manner.

JP 2004-244516 A discloses a lustrous product having high transparency for electromagnetic radiation which can be employed as radiator grille, but also as component of another vehicle part, for example of a tailgate. A layer on a polycarbonate panel here may comprise metal particles, such as zinc, tin or indium, but may instead also be pigmented with interference pigments, such as, for example, titanium dioxide-coated mica. The particles are applied to the panel in a concentration of 3 to 8% by weight in a polyurethane-containing layer. A black base coat is applied thereto as reverseside coating.

The lustrous product obtained comprising a plurality of layers is claimed to have high transparency for electromagnetic radiation and high lustre.

Although good radar wave transparency can be achieved with interference pigments comprising titanium dioxide-coated mica in such coatings, the hiding power of metallic finishes containing metal pigments and the strong metallic lightness flop that can be achieved with the latter is, however, not nearly obtainable just with transparent and colourless mica-based interference pigments of this type having a simple structure.

JP 2006-282886 A also discloses a radar wave-transparent coating for a vehicle part which comprises interference pigments in a layer on a plastic substrate and omits metal-effect pigments. In order to enable colour variance of the coating, the interference pigments are said to be based on particularly smooth substrate particles. Silicon dioxide or aluminium oxide substrate flakes are proposed as suitable substrate flakes. However, the visual impression of a metallic finish can likewise not be achieved with a layer comprising interference pigments of this type on a plastic substrate to be coated.

The object of the present invention consists in providing a radar-compatible, coated plastic part which is suitable for use for cover parts of radar devices, in particular in vehicle construction, and omits conventional metal-effect pigments, in particular aluminium pigments, in its colouring coating, preferably differs as little as possible visually from conventional silver-coloured metallic finishes and in particular has a silver-coloured metallic appearance, high hiding power and a strong lightness flop at the same time as good radar wave transparency.

A further object of the present invention consists in providing a process for the production of the above-mentioned radar-compatible, coated plastic part.

In addition, a further object of the present invention consists in indicating the use of a coated plastic part of this type.

The object of the present invention is achieved by a radar-compatible, coated plastic part, where the plastic part has an optionally precoated and/or pretreated surface provided with a colouring coating that is free from metal-effect pigments and comprises flake-form effect pigments having absorbent properties, where the colouring coating consists of a plurality of layers arranged one above the other, where the flake-form effect pigments are present in each layer and at least two of the layers have geometrical layer thicknesses that are different from one another, and where the surface of the plastic part does not have any further colouring or metallic coating.

In addition, the object of the present invention is also achieved by a process for the production of a coated radar-compatible plastic part of this type, in which a colouring coating that is free from metal-effect pigments and comprises flake-form effect pigments having absorbent properties is applied to an optionally precoated and/or pretreated surface of a plastic part, where the colouring coating is applied in a plurality of layers arranged one above the other, where the flake-form effect pigments having absorbent properties are present in each layer and at least two of the layers have geometrical layer thicknesses that are different from one another, where drying is carried out after application of each layer, and where the surface of the plastic part is not provided with any further colouring or metallic coating.

The object of the invention is also achieved by the use of a plastic part coated as described above as radar-compatible vehicle part.

The present inventors have surprisingly found that it is possible to provide cover parts of radar devices in vehicle construction which have a colouring coating comprising flake-form effect pigments, where the colouring coating overall is free from metal-effect pigments, but can visually have a silver-coloured metallic character.

Although flake-form effect pigments which do not have any metal layers generally do not lead to strong attenuation of the radar signal in coatings, they usually exhibit little or no inherent absorption and only low hiding power. These properties have the effect that an opaque, silver-coloured coating having high lustre and a strong lightness flop, as is characteristic of metallic finishes, cannot be achieved exclusively with the conventional flake-form effect pigments, which are usually interference pigments, in standard coating processes for automobiles.

The aim was therefore to find out the conditions under which colouring coatings which meet the requirements of hiding power, lightness flop and radar compatibility to the greatest possible extent can be obtained on cover parts for radar devices in vehicle production without metal-effect pigments being present in the coating, but the visual appearance of a metallic finish can be imitated to an adequate extent by the colouring coating on the respective plastic part.

The present inventors have found a coated plastic part having a colouring coating which meets the said conditions well.

In accordance with the invention, the colouring coating on the surface of a plastic part consists of a plurality of layers arranged one above the other, which are preferably in each case arranged one above the other over the entire surface and cover the surface of the plastic part. The surface of the plastic part may optionally be precoated and/or pretreated. These are preferably the precoatings that are usual in vehicle construction having a primer layer and/or a filler layer, or also an alternative or additional electrostatic pretreatment on the respective surface. Precoatings and/or pretreatments of this type can influence the adhesion, quality and durability of the subsequent colouring coating, but not its visually perceptible colouration.

In the colouring coating of the surface of the radar-compatible plastic part in accordance with the present invention, each of the individual layers comprises flake-form effect pigments having absorbent properties, but is free from metal-effect pigments. At least two of the layers of the colouring coating have geometrical layer thicknesses that are different from one another. In addition, the surface of the plastic part is not provided with any further colouring coating, apart from with the said multilayered colouring coating, and is likewise not provided with a metallic coating, the latter neither as vapour-deposited metal layer nor as binder-containing coating comprising metal-effect pigments or other metal pigments.

In accordance with the invention, the colouring coating of the radar-compatible plastic part has a multilayered structure and preferably has two to four layers arranged one above the other. It is advantageous here if the colouring coating has a first layer which is located directly on the optionally precoated and/or pretreated surface of the plastic part and has a geometrical layer thickness that is greater than the geometrical layer thickness of each of the individual further layers of the colouring coating that are arranged on this first layer.

This first layer particularly preferably has a geometrical layer thickness that is greater than the sum of the geometrical layer thicknesses of all further layers of the colouring coating. It is likewise particularly preferred here if all further layers apart from the first layer each have the same geometrical layer thickness.

The flake-form effect pigments having absorbent properties in the colouring coating on the surface of the plastic part according to the invention are preferably flake-form effect pigments which have a silver-grey absorption colour.

The optical effect of flake-form interference pigments generally consists of a combination of reflection and transmission phenomena of light at a sequence of thin layers of which effect pigments of this type, usually on a flake-form support material, generally consist. Use is very frequently made here only of materials which are colourless and are transparent to visible light to the greatest possible extent, such as, for example, flake-form mica pigments coated with titanium dioxide. Such pigments can have a silvery interference colour or also chromatic interference colours, but overall are transparent and have no mass tone.

Interference pigments (such pigments are referred to below as flake-form pigments having absorbent properties) achieve absorbent properties and thus a mass tone if either the flake-form support or alternatively at least one of the layers located on the flake-form support consists of a material that has an inherent colour, i.e. an absorption colour. These can be coloured metal oxides, metal suboxides, metal oxynitrides, mixed metal oxides or oxygen-deficient metal oxides, or metal oxide hydrates. Interference pigments also achieve absorbent properties due to layers which comprise organic coloured pigments.

In accordance with the present invention, flake-form effect pigments having a silver-grey absorption colour which have at least one layer which comprises or consists of an iron oxide (Fe(II) and/or Fe(III)), a mixed oxide comprising iron oxide and titanium oxide, a titanium suboxide or titanium oxynitride, or have a layer which comprises or consists of carbon, are preferably employed in the colouring coating. One or more other layers comprising colourless, transparent materials may additionally be located on the flake-form support material.

Iron oxides or iron oxide hydrates which come into consideration are Fe₂O₃, FeO, Fe₃O₄ or FeOOH. Mixed oxides of iron oxide and titanium oxide are frequently ilmenite (FeTiO₃) or pseudobrookite (Fe₂TiO₅). Suitable titanium suboxides are TiO, Ti₂O₃, Ti₃O₅, Ti₄O₇, Ti₂O, Ti₃O or Ti₆O.

The layer thicknesses of the absorbent layers comprising an iron oxide, a mixed oxide comprising iron oxide and titanium oxide, titanium oxynitride or a titanium suboxide, or the layer which comprises carbon or consists of carbon, are set so that the effect pigment has a silver-grey absorption colour. By contrast, all other layers optionally present on the support material do not make a contribution to the absorption colour.

Suitable further colourless transparent layers on the flake-form support material are, in particular, layers comprising colourless metal oxides or metal oxide hydrates, such as tin oxide, titanium dioxide, zirconium oxide, silicon dioxide, silicon oxide hydrate, aluminium oxide or aluminium oxide hydrate.

Flake-form support materials which come into consideration are natural or synthetic mica, kaolin, talc or sericite, in addition also glass, calcium aluminium borosilicate, SiO₂, TiO₂ or Al₂O₃. The flake-form support materials employed are preferably natural or synthetic mica or Al₂O₃ flakes.

Flake-form effect pigments of the said type are commercially available. They can be obtained, for example, from Merck KGaA under the trade names Iriodin® 9602 Silver-Grey SW, Iriodin® 9605 Blue Shade Silver SW or Iriodin® 9612 Silver-Grey Fine Satin SW. These are based on mica flakes and have at least one layer which comprises an iron oxide or a titanium suboxide.

It is preferably also possible to employ flake-form effect pigments having absorbent properties which have one or more interference layers and, as the final layer, a very thin, light-transmitting layer consisting of carbon, on a transparent support flake. Such pigments have been described, for example, in the patent application EP 3795645 A1 by the present patent applicant.

It has been found that effect pigments having a silver-grey absorption colour are particularly suitable for use as flake-form effect pigments having absorbent properties in the colouring coating since the latter is intended to have a silver-metallic appearance. Due to the pigment structure in the form of sequences of thin layers on flake-form substrates, effect pigments of this type exhibit a visually perceptible lustre when incident light hits them. The silver-grey absorption colour effects sufficiently high lightness in the case of direct incidence of light.

These flake-form effect pigments having absorbent properties generally have particle sizes in the range from 1 to 100 μm, in particular from 2 to 70 μm and particularly preferably in the range from 3 to 20 μm. The thickness of the effect pigments is in the range from 0.1 to 2 μm.

The particle size of the flake-form effect pigments can be determined by means of laser diffractometry. The particle size and the particle size distribution in relation to volume is preferably determined using a Malvern instrument (Malvern Mastersizer 3000, APA300, product from Malvern Instruments Ltd., UK) in standard mode. However, usual particle size ratios can also be found in the manufacturer's data in publicly accessible product information sheets.

In this size range, a sufficiently good hiding power of the colouring coating can be obtained if the amount of the effect pigments having absorbent properties and the total layer thickness of the colouring coating are set in accordance with the invention.

It may also be advantageous to employ flake-form effect pigments having absorbent properties in mixtures in which the effect pigments employed have different particle sizes.

In accordance with the invention, the minimum amount of flake-form effect pigments having absorbent properties in each of the individual layers of the colouring coating is 5% by weight, based on the weight of each of the (solid) individual layers. The maximum amount of flake-form effect pigments having absorbent properties in each of the individual layers of the colouring coating is 40% by weight, based on the weight of the respective layer. These effect pigments are preferably employed in each layer of the colouring coating in a concentration of 10 to 30% by weight, based on the respective weight (dry weight) of the layer.

It is particularly preferred if the content and type of the flake-form effect pigment(s) having absorbent properties is the same in each individual layer of the colouring coating, since the process for the production of the plastic bodies coated in accordance with the invention is thereby noticeably simplified and unwanted colour deviations of the coating as a whole can be prevented.

In a first embodiment of the present invention, no further flake-form effect pigments apart from the flake-form effect pigments having absorbent properties are present in the colouring coating.

In a second embodiment of the present invention, the flake-form effect pigments having absorbent properties are present in the colouring coating in a mixture with flake-form effect pigments without absorbent properties. In this case, the ratio of flake-form effect pigments having absorbent properties to flake-form effect pigments without absorbent properties is in the range from 2:1 to 10:1. A mixture of this type is preferably present in each individual layer of the multilayered colouring coating and the mixing ratio is the same in each layer, in particular also with use of the same flake-form effect pigments in each layer.

Suitable flake-form effect pigments without absorbent properties are, in particular, interference pigments having a silver-grey interference colour.

These are based on transparent, colourless, flake-form support materials, such as natural or synthetic mica, kaolin, talc or sericite, or on glass, calcium aluminium borosilicate, SiO₂, TiO₂ or Al₂O₃. The flake-form support materials employed are preferably natural or synthetic mica or Al₂O₃ flakes.

The flake-form support materials are coated with one or more layers of transparent, colourless metal oxides or metal oxide hydrates, such as tin oxide, titanium dioxide, zirconium oxide, silicon dioxide, silicon oxide hydrate, aluminium oxide or aluminium oxide hydrate. Flake-form effect pigments of this type merely have an interference colour and no mass tone.

Commercially available interference pigments which are offered by various manufacturers are suitable. Interference pigments having a silver-grey interference colour are preferably employed. Mention may be made here by way of example of Iriodin® 9103 Rutile Sterling Silver SW from Merck KGaA.

The flake-form effect pigments without absorbent properties have particle sizes in the range from 1 to 250 μm, in particular from 2 to 100 μm. The thickness of these effect pigments is in the range from 0.1 to 2 μm.

If, in accordance with the second embodiment of the present invention, a mixture of flake-form effect pigments is employed in the colouring coating, the minimum proportion of flake-form effect pigments having absorbent properties in each layer of the colouring coating is 5% by weight, based on the weight of the respective layer, as already described above. The proportion of flake-form effect pigments having absorbent properties in each layer is preferably at least 10% by weight, with a total proportion of flake-form effect pigments with and without absorbent properties of at most 40% by weight, in each case based on the weight of the respective layer, and observing the above-mentioned mixing ratios.

As already described above, the same flake-form effect pigments in the same weight and mixing ratios in each case are preferably employed in each of the layers of the colouring coating.

In accordance with the invention, the geometrical total layer thickness of the colouring coating is in the range from 8 to 25 μm, preferably in the range from 10 to 20 μm.

If it appears advantageous, the colouring coating may also comprise one or more so-called absorption pigments, so long as this does not adversely influence the optical measurement values of the coating, for example for the hiding power (ΔE*), the lightness (L*15) and the lightness flop (flop index).

Suitable absorption pigments are organic or inorganic pigments having absorbent properties. These are essentially the classical organic absorption pigments or inorganic absorbent pigments. All absorption pigments that are usually employed in various industrial coatings can be used for this purpose. These are preferably available with a particle diameter in the range from 10 to 500 nm, in particular from 10 to <100 nm. Preparations of absorption pigments are generally commercially available. Depending on compatibility with the paint systems employed, systems such as, for example, Heucotint® W (Heubach, DE), Heucotint® UN (Heubach, DE), MIPA WBC (Mipa, DE), Standoblue® (Standox GmbH, DE), Standohyd® (Standox GmbH, DE), Vocaflex® (Arichemie, DE), Vocaplast® (Arichemie, DE), or also others come into consideration.

Suitable absorption pigments are, for example, isoindolidones, benzimidazoles, quinacridones, Cu phthalocyanines, perylenes, carbon black and/or titanium dioxide, to mention just a few. Coloured absorption pigments can be employed in suitable mixtures in order to obtain a neutral, achromatic colouration.

White, grey or black are usually not referred to as colours in expert circles, since these are achromatic optical phenomena which merely denote the amount of light absorbed by the respective surface. In the present invention, by contrast, white, grey and black are, however, intended to be referred to as colours. To this extent, the coating on the surface of the plastic part according to the invention can, in accordance with the invention, also be referred to as “colouring”, although the “coloration” preferably aimed at here is a visually silvery metallic impression which can be described as “silver-grey” and thus represents a mixture of white and black if the lustre factor is disregarded.

The overall optical effect of the multilayered, colouring coating according to the invention on the surface of the plastic part gives rise to a homogeneous silver-metallic overall impression of the coating according to the invention having high hiding power for the application, high lustre and a clear lightness flop.

The hiding power here is determined from the ΔE* values, which can be determined on spectrophotometric measurement of coated substrates in the L*,a*,b* colour space. The quantity ΔE* is defined here as the colour separation of samples in the L*a*b* colour space over a standardised black and white background at an illumination angle of 45° and a viewing angle of 75° and is determined in accordance with the formula:

$$Δ {E}^{⋆} = √ ( Δ {L}^{⋆ 2} + Δ {a}^{⋆ 2} + Δ {b}^{⋆ 2} ) .$$

The lower the value for the colour separation turns out, the better the coating hides the background. Complete hiding of the background generally cannot be achieved with non-metallic effect pigments, but can be achieved very substantially in the present case. The colouring coating employed in accordance with the invention has a ΔE* value in the range from 0 to 3, preferably in the range from 0 to 1, when it is applied to the black/white background in a layer thickness in the range 14±2 μm and is measured under the above-mentioned measurement conditions. These values indicate a hiding power of the colouring coating that is very good for the purposes of the present invention.

A measure used in expert circles for the lightness of a layer is the L*15 value of a coating, which is determined photometrically in the L*,a*,b* colour space on a standardised black/white background at an illumination angle of 45° and at a viewing angle of 15°. In order to be suitable as coating according to the invention, this should have a minimum lightness, which is obtained both over a white base layer and also over a black base layer.

On use of the above-mentioned effect pigments having a silver-grey absorption colour in the colouring coating, a colouring coating is obtained which, when it is applied to the full area of a black/white background in a layer thickness of 14±2 μm and is measured spectrophotometrically in the L*,a*,b* colour space at an illumination angle of 45° and at a viewing angle of 15°, has a lightness L*15 of at least 80 both on the coated white background and on the coated black background.

In addition, a good lightness flop can also be achieved. As standard, this is expressed as the flop index and is determined spectrophotometrically at an illumination angle of 45° and at an aspecular separation of 15°, 45° and 110° from the specular angle. In accordance with the invention, the flop index on a black-coated background is therefore in the region of at least 12 if the colouring coating, when it is applied to the full area of a black/white background in a layer thickness of 14±2 μm and is measured spectrophotometrically in the L*, a*,b* colour space at an illumination angle of 45° and at viewing angles of 45°: as15°, 45°: as45° and 45°: as110°.

The flop index is usually regarded in the art as a measure of the lightness flop at varying viewing angles and is determined in accordance with the formula:

$$flop index = \frac{2.69 {( {L}_{1 {5}^{∘}}^{⋆} - {L}_{11 {0}^{∘}}^{⋆} )}^{1.11}}{{( {L}_{4 {5}^{∘}}^{⋆} )}^{0.86}}$$

The quoting of upper limit values is not appropriate either in the case of the lightness L*15 or in the case of the flop index since both quantities have open upper limits and measurement results that are above the stated minimum values in each case have a positive effect on the overall optical result on observance of a hiding power in the stated range.

Details on the spectrophotometric measurement methods and instruments are described in the example part.

Surprisingly, it has been found that a multilayered colouring coating on a plastic substrate in accordance with the present invention exhibits significantly better properties both in respect of the lightness and also in relation to the lightness flop, demonstrated by the flop index, compared with a single-layered coating of the same total layer thickness (dry layer thickness) and regarding the colouring pigments of identical pigmentation. This opens up the suitability of a plastic part coated in accordance with the invention for use as cover part for radar devices in vehicles. The colouring coating of the plastic part according to the invention is visually very similar to a classical metallic coating. At the same time, the avoidance of effect pigments which consist of metals or comprise metal layers ensures good radar wave transparency, so that the radar devices installed in the vehicle interior are simultaneously not visible and are not impermissibly impaired in their function.

The colouring coating on the plastic part in accordance with the present invention consists of two or more, preferably of three or four, layers arranged one above the other. The total dry layer thickness of the colouring coating here is in the range from 8 to 25 μm.

The dry layer thickness of the first layer of the colouring coating, which is located directly on the surface of the plastic part according to the invention, is preferably at least 5 μm, preferably greater than or equal to 8 μm, and represents the layer of the colouring coating that has the greatest dry layer thickness (the surface of the plastic part may optionally be precoated and/or pretreated, as described above, where the pretreatment and/or precoating does not determine the perceptible colour impression).

All further layers of the colouring coating preferably have lower dry layer thicknesses than the first layer and at least one of the layers, preferably two or three of the layers, have a dry layer thickness of in each case <5 μm. In particular, the dry layer thickness of at least one of the further layers is ≤4 μm or ≤3 μm, particularly preferably about 2 μm. These extremely low layer thicknesses can be present, in particular, in two or three of the further layers, it being very particularly preferred if all layers apart from the first layer have the same low dry layer thickness.

In order to be able to combine such thin multilayered layer structures to give a visually attractive colouring coating on a plastic part, smooth surfaces of the individual layers are necessary. These arise from interfaces between the individual layers of the colouring coating which are arranged very substantially parallel to the surface of the plastic part. The interfaces are obtained by interim drying after application of each of the individual layers of the colouring coating. Due to the interim drying, the flake-form effect pigments with and, in the second embodiment, also the flake-form effect pigments without absorbent properties in each of the individual layers are aligned with their principal axes approximately parallel to the surface of the plastic part or the precoating on the surface of the plastic part and thus achieve good reflection of the incident light in each individual layer of the colouring coating.

The pigment loading of the individual layers here is likewise at least 5% by weight of flake-form effect pigments having absorbent properties and is a maximum of 40% by weight of flake-form effect pigments in total, in each case based on the weight of the individual layer. Preferably, 10 to 30% by weight of flake-form effect pigments having absorbent properties are employed in each of the layers of the colouring coating.

“Radar-compatible” in the sense of the present invention is taken to mean a coating which has a permittivity of <30 on exposure to electromagnetic waves having a peak frequency of 76.5 GHZ. Furthermore, it is necessary for the coating on a 350 μm PET substrate to have one-way transmission attenuation of <2 dB on exposure to electromagnetic waves having a peak frequency of 76.5 GHZ.

The measurement of the permittivity of the coating and the one-way transmission attenuation of the coating on the substrate is carried out using an RMS-D-77/79G instrument from perisens GmbH, Germany, in standard mode.

The binders employed for the colouring coating can be all conventional binders and binder systems that appear transparent in the solidified state. Recourse can be made here to all standard binder types that are employed in conventional coating processes and are compatible with the pigments employed. Solvent-based binder systems, aqueous binder systems and radiation-curing binder systems can be employed equally, so long as special factors that are usual in the art in the choice of pigment and regarding the coating process are observed.

The colouring coating may comprise further additives that are usual in the art, such as, for example, fillers, inhibitors, flameproofing agents, lubricants, rheology aids, dispersants, redispersants, antifoams, flow-control agents, film formers, adhesion promoters, drying accelerators, photoinitiators, etc.

In the case of a desired dry layer thickness of the second and, where present, each further layer of the colouring coating in the range <5 μm, the use of rheology aids is generally indicated. Rheology aids which come into consideration are substances such as, for example, BaSO₄, polyamide powder, silicates or other rheology aids that are familiar to the person skilled in the art, but in particular cellulose-based nanofibres. The latter are particularly preferably employed. These rheology aids permit the formation of coherent, particularly thin pigment-containing layers on the surface to be coated in each case.

Depending on the binder system employed, the coating compositions employed for the production of the colouring coating optionally also comprise organic solvents and/or water, which, however, are no longer present in the colouring coating of the plastic part according to the invention after solidification or drying of the individual layers. The solvent systems that are usual in the art can be employed without restrictions.

Corresponding compositions for binder systems, including solvents and additives, are adequately known to the person skilled in the art and in some cases are also commercially available in the unpigmented state as finished products. A corresponding selection can be made by the person skilled in the art on the basis of the respective pigmentation to be employed and the desired coating process.

As plastic part to which the multilayered colouring coating is applied, plastic plates or films come into consideration if the coating is intended to be radar-compatible. The plastics usually used in automobile construction can be used here, for example polycarbonate (PC), polypropylene (PP), polyurethane (PUR), polymethyl methacrylate (PMMA), acrylonitrile-butadienestyrene (ABS) or acrylonitrile-ethylene-styrene (AES) substrates, to mention just a few. Plastic plates or plastic films of this type have a certain base attenuation of the radar signal, which should experience only a slight increase due to the colouring coating located thereon. In respect of the radar compatibility of the plastic part according to the invention, the value of the base attenuation of the radar signal with respect to one-way transmission, which is present due to the respective plastic substrate, is included in the measurement values. The base attenuation of the one-way transmission of the radar signal that is caused solely by the plastic substrate is indicated separately in Example 4. Measurement of the radar signal attenuation caused solely by the coating is not possible for technical equipment-related reasons.

If the colouring coating is intended to be applied to any desired substrates for purely optical reasons and if the focus is not on the radar compatibility of the coating, it is of course also possible to employ metallic or metal-containing substrates.

It goes without saying that the plastic parts can be three-dimensionally shaped, i.e. can have a three-dimensional outer shape, depending on the application. Thus, example, a plastic plate which is intended to form a component of a vehicle tailgate naturally has a different three-dimensional outer shape than a plastic plate intended as bumper. In general, the three-dimensional shape of the plastic part is generated by means of conventional shaping processes before application of the colouring coating.

An indispensable core element of the plastic part according to the invention is the multilayered colouring coating as described above. In addition, further layers, which may likewise be part of the plastic part according to the invention, may optionally also be located between the plastic surface of the plastic part and the first layer of the colouring coating and/or above the colouring coating.

One or more layer(s), which may optionally be located between the plastic surface of the plastic part and the colouring coating, are, as already described above, primer layers or filler layers. Such additional layers are frequently employed in automobile construction in order optionally to improve the adhesion of the paint layers to the respective substrate and/or to improve the mechanical and chemical strength of the paint layers. These are primer layers which do not determine the visually perceptible colour impression of the coated plastic part. By contrast, an outermost layer is preferably also applied to the surface of the colouring coating in order to improve the weathering resistance of the colouring coating. A layer of this type is usually referred to as clear coat and is generally designed to be transparent and colourless, but may also comprise extremely small amounts of pigments. The plastic part in accordance with the present invention can advantageously have a primer layer and/or a clear coat. In accordance with the invention, it is possible to employ all conventional materials which are widely used industrially and therefore do not require further explanation.

The plastic part coated in accordance with the invention can advantageously be employed in all cases where radar devices are to be provided with covers which visually have a silver-coloured effect finish without the functionality of the radar devices being adversely influenced. This naturally applies, in particular, to cover parts used in vehicle construction. The plastic part coated in accordance with the invention is preferably a vehicle part. Owing to its good optical properties, the colouring coating as such can of course also be used for finishes of all types that are intended to correspond visually to a conventional silver-coloured metallic finish to the greatest possible extent. The radar wave transparency present may also play a subordinate role here and the corresponding areas of use are not restricted to vehicle construction.

The present invention also relates to a process for the production of a radar-compatible plastic part, in which a colouring coating that is free from metal-effect pigments and comprises flake-form effect pigments having absorbent properties is applied to an optionally precoated and/or pretreated surface of a plastic part, where the colouring coating is applied in a plurality of layers arranged one above the other, the flake-form effect pigments having absorbent properties are present in each layer and at least two of the layers have geometrical layer thicknesses that are different from one another, where drying is carried out after application of each layer, and where the surface of the plastic part is not provided with any further colouring or metallic coating.

All material details in relation to the suitable plastic parts and the material composition of the multilayered colouring coating have already been explained above. To this extent, reference is made here thereto.

The application of the individual layers of the colouring coating to the surface of the optionally precoated and/pretreated plastic part can be carried out by means of conventional coating processes, for example by spray processes, in-mould processes, roller-coating processes, curtain-coating processes or by electrostatic application processes.

Coating processes of this type are standard in large-scale industry and can be employed in accordance with the art.

Spray processes or electrostatic application processes are preferably employed.

Conventional spray technologies, in which dry layer thicknesses in the range from 5 to 25 μm can be obtained with a single spray operation, are suitable for the production of the first layer of the colouring coating. This application step is completed by an interim drying.

However, for the application of the second and, where present, each further layer of the colouring coating having a dry layer thickness of <5 μm, spray processes that allow layers arranged one on top of the other to be applied successively to the first layer of the colouring coating in a plurality of working steps with very low dry layer thickness of the individual layers are particularly suitable. These preferably one to three layers are in each case likewise dried after application of each individual layer, so that interfaces form between the individual part-layers. The temperature for the drying of the individual layers is dependent on the respective binder system and the solvents employed and is at least 20° C. Temperatures up to 150° C., preferably up to 100° C., can be employed.

The amount of flake-form effect pigments having absorbent properties in the colouring coating here is at least 5% by weight, based on the weight of the dry layer, for each of the individual layers, but can be in the range from 10 to 40% by weight, in particular in the range from 10 to 30% by weight. The dry layer thickness of at least one of the layers is <5 μm, preferably ≤4 μm and in particular≤3 μm or about 2 μm. Preferably, two or three layers have such low layer thicknesses.

The high pigment concentration in the respective layers of the colouring coating in the case of a very low dry layer thickness of the individual layers can be established by very considerably reducing the proportion of binders in the respective coating composition (solids content about 6 to 7% by weight) and very considerably increasing the proportion of solvents (preferably water). In order that a very dilute coating composition of this type can form a continuous coating film on the surface to be coated, various assistants, in particular rheology aids, are added which ensure that a suitable viscosity of the coating composition is established, so that this can be applied to the background by means of a spray process and exhibits good flow properties. In the course of the subsequent drying process, a small solid mass having a very high proportion of flake-form effect pigments remains on the respective background as a single layer, in which the effect pigments are present with their principal axes also aligned well and essentially parallel to the respective coated surface.

As rheology aids, cellulose-based nanofibres are preferably added here in an amount of 5 to 20% by weight, based on the weight of the respective coating composition.

Due to the multiple application of individual layers arranged one above the other and the respective interim drying of these layers, the flake-form effect pigments in the multilayered colouring coating can be oriented particularly well, so that high reflection of incident light at the surface of the colouring coating is obtained. This improves, in particular, the lightness flop of the colouring coating, enabling a high hiding power of the coating and good overall lightness to be achieved at the same time. A coated plastic part whose colouring coating very substantially corresponds visibly to a silver-coloured metallic coating, but has good radar compatibility, can thus be obtained with flake-form effect pigments having absorbent properties in the colouring coating and without the use of metal pigments of all types in the coating as a whole.

The colouring coating is applied with a total dry layer thickness which is preferably in the range from 8 to 25 m.

In particular, the application of the colouring coating is carried out as a spray process in two to four part-steps by applying two to four layers successively and in each case one on top of the other, where the amount of flake-form effect pigments having absorbent properties in each of the layers is at least 5% by weight, based on the dry weight of the respective layer, and where drying is carried out at a temperature of at least 20° C. after application of each layer.

The surface of the plastic parts employed, which have predefined radar properties, can optionally be electrostatically pretreated and/or precoated, for example with one or more primer or filler layers, as already described above. However, in order to ensure the radar-compatible character of the coating as a whole, it must be ensured that none of the layers optionally additionally present on the surface of the plastic part comprises metal-effect pigments, other metal pigments, metal layers or other constituents that could impair the requisite radar wave transparency of the coating as a whole.

Precoating of the surface of the plastic part with a primer layer is advantageous since such primer layers improve, inter alia, the mechanical stability of the coating as a whole and the adhesion of the first layer of the layer package to the substrate. In addition, outermost clear coats, which are generally designed to be colourless and transparent to visible light, are advantageous, in particular for the mechanical stability and the weathering resistance of coatings. In the present invention too, they are preferably applied to the surface of the colouring coating as the outermost layer of the coating as a whole. Clear coats which comprise absorption pigments or effect pigments with a PMC of <2% are also occasionally employed in technical applications. In accordance with the present invention, such clear coats will not be referred to as colouring and can likewise be employed on the surface of the plastic part according to the invention.

It goes without saying that the coating as a whole is subjected to at least one hardening operation, which is carried out either after application and drying of the colouring coating and/or after application of the clear coat. The hardening of coatings on substrates, including plastic substrates, in particular in the automobile sector, is a standard activity in the art and need not be described in greater detail.

The present invention also relates to the use of the plastic part described above with colouring coating which is free from metal-effect pigments as vehicle part, in particular as radar-compatible vehicle part. It can be employed, for example, as external bodywork part which are intended as outer cover or screening part for radar devices installed in the vehicle interior. Bodywork parts which may be mentioned are, in particular, bumpers, tailgates, radiator grilles, wings or parts thereof. The colouring coating can of course also be applied to vehicle parts other than those mentioned and in particular also to metal-containing substrates if only the visual appearance of a metallic finish is of interest and the radar compatibility is not necessary. In the latter case, the area of application of the invention is also not restricted to vehicle construction.

The invention is intended to be explained below with reference to examples, but not restricted thereto.

### EXAMPLES

In order to measure the optical properties of the colouring coating, these are applied to standardised black/white-coated Leneta panels (white and black standard coating present on the respective part-area). The coating is carried out as pneumatic spray coating. The binder employed is the preparation WBC 000 from MIPA SE, DE. Finally, all samples are coated with a standard 2-component clear coat.

Various mixtures of flake-form effect pigments are employed for the colouring coating.
Effect pigment 1: effect pigment having absorbent properties based on mica with a coating comprising SnO₂, TiO₂, iron oxide and assistants, particle size <15 μm; silver-grey absorption colour
Effect pigment 2: effect pigment without absorbent properties based on mica with a coating comprising SnO₂, TiO₂ and assistants, particle size <100 μm; silver-grey interference colour

The mixing ratio in the coating compositions is:

$$Composition A : pigment 1 : pigment 2 = about 3 : 1$$

$$Composition {A}^{′} : pigment 1 : pigment 2 = about 3 : 1$$

$$Composition B : pigment 1 : pigment 2 = about 8 : 1$$

$$Composition {B}^{′} : pigment 1 : pigment 2 = about 8 : 1$$

Each composition additionally comprises classical absorption pigments (0.55% present in PMC).

### Example 1

In order to determine the hiding power of the colouring coating, coating compositions A, A′, B and B′, in each case having a pigment mass concentration of 28% by weight, based on the weight of the solid coating, are applied both in a single coating operation (comparison) and in a multicoat application according to the invention, to the standardised black-and-white-coated panels and dried at 80° C. for 5 minutes after each application step. In the case of the multicoat application according to the invention, the colouring coating is applied in four layers (in each case 28% by weight PMC, layer thicknesses 9, 2, 2, 2 μm, drying in each case for 5 min. at 80° C.). The lower the colour separation ΔE* 75° comes out, the better the hiding power of the respective colouring coating.

TABLE 1
Hiding power

| Mixture | Layers | Process | PMC (%) | DLT (μm) | ΔE* 75° |
|---|---|---|---|---|---|
| A | 1 | pneumatic | 28 | 15 | 0.65 |
| A′ | 4 | pneumatic | 28 | 15 | 0.55 |
| B | 1 | pneumatic | 28 | 15 | 0.40 |
| B′ | 4 | pneumatic | 28 | 15 | 0.25 |

Layers: number of layers colouring coating
   1 layer: comparison
   4 layers: invention
PMC: pigment mass concentration of colouring pigments in each layer
DLT: dry layer thickness of the entire colouring coating
L*: lightness value L* in the L*a*b* colour space at a viewing angle of 15°, illumination angle 45°
ΔΕ *: colour separation of samples in the L*a*b* colour space over standardised black and white background (illumination angle 45°, viewing angle 75°), determined in accordance with the formula:

$$Δ {E}^{⋆} = √ ( Δ {L}^{⋆ 2} + Δ {a}^{⋆ 2} + Δ {b}^{⋆ 2} )$$

Flop index: measure of the lightness flop at varying viewing angle (illumination angle 45°, viewing angle 45°: as15°, 45°: as45°, 45°: as110°), determined in accordance with the formula:

$$flop index = \frac{2.69 {( {L}_{1 {5}^{∘}}^{⋆} - {L}_{11 {0}^{∘}}^{⋆} )}^{1.11}}{{( {L}_{4 {5}^{∘}}^{⋆} )}^{0.86}}$$

### Example 2

In order to determine the lightness of the respective coating, coating compositions A, A′, B and B′ are applied as in Example 1 to the respective black background. In addition to the pneumatic spray application process, an electrostatic process is employed since electrostatic application processes are used as standard in OEM coating plants. The greater the lightness values L*15 come out, the better a coating pigmented opaquely merely with aluminium pigments can be imitated visually.

TABLE 2
Lightness

| Mixture | Layers | Process | PMC (%) | DLT (μm) | L* 15 |
|---|---|---|---|---|---|
| A | 1 | pneumatic | 28 | 15 | 85 |
| A1′ | 4 | pneumatic | 28 | 15 | 91 |
| A | 1 | electrostatic | 28 | 15 | 75 |
| A′ | 4 | electrostatic | 28 | 15 | 88 |
| B | 1 | pneumatic | 28 | 15 | 74 |
| B′ | 4 | pneumatic | 28 | 15 | 84 |
| B | 1 | electrostatic | 28 | 15 | 67 |
| B′ | 4 | electrostatic | 28 | 15 | 80 |

In the case of the colouring layer structure according to the invention, high lightness values which exceed the lightness values in the case of a single application of a corresponding coating composition can be obtained with each coating process and each of the effect pigment mixtures employed.

### Example 3

In order to determine the flop index, all coatings produced in Example 2 are re-measured.

TABLE 3
Flop index

| Mixture | Layers | Process | PMC (%) | DLT (μm) | Flop index |
|---|---|---|---|---|---|
| A | 1 | pneumatic | 28 | 15 | 11.5 |
| A′ | 4 | pneumatic | 28 | 15 | 13.8 |
| A | 1 | electrostatic | 28 | 15 | 10.5 |
| A′ | 4 | electrostatic | 28 | 15 | 14.0 |
| B | 1 | pneumatic | 28 | 15 | 9.5 |
| B′ | 4 | pneumatic | 28 | 15 | 12.0 |
| B | 1 | electrostatic | 28 | 15 | 9.0 |
| B′ | 4 | electrostatic | 28 | 15 | 12.5 |

Conventional silver-metallic coatings, which generally comprise aluminium pigments, have flop indices in the range from about 12 to 17. This range can be achieved by all substrates provided with the colouring coating in accordance with the present invention.

The colorimetric measurement of the samples is carried out using a model BYKMac i colorimeter (Byk-Gardner) in SMC5 mode.

The black/white panels used as substrate here comply with the ASTM E 1347 standard and are marketed by Leneta under the name Metopac T12G panels.

It can be seen from the tables that the colouring coatings with each of the mixture used here comprising flake-form effect pigments having a silver-grey absorption colour and flake-form effect pigments having a silver-grey interference colour and each of the coating process variants used achieve good lightness and a good lightness flop the same time as a very high hiding power and are therefore capable of visually imitating metallic coatings comprising aluminium pigments in a good to very good manner. Since no metal pigments are present in the coatings, significant attenuation of radar waves by the respective coating on the plastic substrate is not expected.

### Example 4

In order to determine the radar wave transparency, a PET film with a thickness of 350 μm (Hostaphan RN 350, Mitsubishi Polyester Film GmbH, DE) is employed as substrate in each case. The coating is carried out as pneumatic spray coating. The binder employed is the preparation WBC 000 from MIPA SE, DE.

The colouring coating applied in each case is a layer comprising the effect pigment mixtures shown in Table 4 having a silver-grey absorption colour or silver-grey interference colour in one or four layers in each case and dried as described in Example 1.

Table 4 shows the dielectric constant (permittivity) of the respective layer structure and the attenuation of the radar signal in dB for a single beam passage (76.5 GHZ) (instrument: RMS-D-77/79G from perisens GmbH, DE, standard mode)

The uncoated PET substrate has a permittivity of about 3.0 and a radar wave attenuation of 1.05 dB.

A coating comprising a single layer on the PET substrate which comprises commercially available aluminium pigments and has a PMC of 18% by weight and a DLT of about 22 μm has, for comparison, a permittivity of about 74.9 and a one-way attenuation of the radar signal of about 4.5 dB under the same measurement conditions.

TABLE 4
Radar wave transparency

| | | | | | Attenuation |
|---|---|---|---|---|---|
| | | | | | at 76.5 |
| Mixture | Layers | PMC (%) | DLT (μm) | Permittivity | GHz (dB) |
| A | 1 | 28 | 15 | 5.12 | 1.10 |
| A′ | 4 | 28 | 15 | 5.04 | 1.10 |
| B | 1 | 28 | 15 | 4.81 | 1.10 |
| B# | 4 | 28 | 15 | 5.33 | 1.10 |

The multistep coating process does not adversely change the radar wave transparency of a colouring coating pigmented merely with metal-free effect pigments on a plastic part (here plastic film). The plastic part according to the invention therefore has good radar wave transparency.

1. A radar-compatible, coated plastic part, wherein the plastic part has an optionally precoated and/or pretreated surface that is provided with a colouring coating that is free from metal-effect pigments and comprises flake-form effect pigments having absorbent properties, wherein the colouring coating comprises a plurality of layers arranged one above the other, wherein the flake-form effect pigments having absorbent properties are present in each layer and at least two of the layers have geometrical layer thicknesses that are different from one another, and wherein the surface of the plastic part does not have any further colouring or metallic coating.

2. The radar-compatible plastic part according to claim 1, wherein the colouring coating has two to four layers arranged one above the other.

3. The radar-compatible plastic part according to claim 1, wherein the colouring coating has a first layer which is located directly on the optionally precoated and/or pretreated surface of the plastic part and has a geometrical layer thickness that is greater than the geometrical layer thickness of each of the individual further layers arranged on the first layer.

4. The radar-compatible plastic part according to claim 1, wherein the flake-form effect pigments having absorbent properties are present in each layer of the colouring coating in an amount of at least 5% by weight, based on the weight of the respective layer of the coating.

5. The radar-compatible plastic part according to claim 1, wherein no further flake-form effect pigments apart from the flake-form effect pigments having absorbent properties are present in the colouring coating.

6. The radar-compatible plastic part according to claim 1, wherein the flake-form effect pigments having absorbent properties are present in the colouring coating in a mixture with flake-form effect pigments without absorbent properties.

7. The radar-compatible plastic part according to claim 1, wherein the colouring coating, when it is applied over the full area of a black/white background in a total layer thickness of 14±2 μm and is measured spectrophotometrically in the L*,a*, b* colour space at an illumination angle of 45° and at a viewing angle of 75°, has a colour separation ΔE* between the coated white background and on the coated black background in the range from 0 to 3.

8. The radar-compatible plastic part according to claim 1, wherein the colouring coating, when it is applied to the full area of a black/white background in a total layer thickness of 14±2 μm and is measured spectrophotometrically in the L*,a*,b* colour space at an illumination angle of 45° and at a viewing angle of 15°, has a lightness L*15 of at least 80 both on the coated white background and on the coated black background.

9. The radar-compatible plastic part according to claim 1, wherein the colouring coating, when it is applied to the full area of a black/white background in a total layer thickness of 14±2 μm and is measured spectrophotometrically in the L*,a*,b* colour space at an illumination angle of 45° and at viewing angles of 45°: as 15°, 45°: as45° and 45°: as110°, in each case has a flop index of at least 12 on the coated black background.

10. The radar-compatible plastic part according to claim 1, wherein the colouring coating comprises, as flake-form effect pigment having absorbent properties, an effect pigment which has a silver-grey absorption colour.

11. The radar-compatible plastic part according to claim 10, wherein the effect pigment having a silver-grey absorption colour is a pigment that has at least one layer which comprises an iron oxide, a titanium suboxide, a titanium oxynitride or a mixture of iron oxide and titanium oxide, or has a layer that comprises carbon or consists of carbon, on a transparent flake-form support material.

12. The radar-compatible plastic part according to claim 1, wherein the colouring coating comprises flake-form effect pigments in a concentration in the range from 5 to 40% by weight, based on the weight of the respective layer of the coating, in each layer of the coating.

13. The radar-compatible plastic part according to claim 1, wherein the colouring coating has a total layer thickness in the range from 8 to 25 μm.

14. The radar-compatible plastic part according to claim 1, wherein the plastic part is a plastic plate or film, wherein the plastic part can optionally have a three-dimensional outer shape.

15. The radar-compatible plastic part according to claim 1, wherein at least one further layer is located above the colouring coating.

16. The radar-compatible plastic part according to claim 15, wherein the further layer is an outermost clear coat.

17. The radar-compatible plastic part according to claim 1, wherein the surface of the plastic part is precoated with a primer layer and/or a filler layer and/or electrostatically pretreated.

18. A process for the production of a radar-compatible plastic part, wherein a colouring coating that is free from metal-effect pigments and comprises flake-form effect pigments having absorbent properties is applied to an optionally precoated and/or pretreated surface of a plastic part, wherein the colouring coating is applied in a plurality of layers arranged one above the other, where the flake-form effect pigments having absorbent properties are present in each layer and at least two of the layers have geometrical layer thicknesses that are different from one another, where drying is carried out after application of each layer, and where the surface of the plastic part is not provided with any further colouring or metallic coating.

19. The process according to claim 18, wherein the colouring coating is applied with a total dry layer thickness in the range from 8 to 25 μm.

20. The process according to claim 18, wherein the colouring coating comprises flake-form effect pigments in an amount of 5 to 40% by weight, based on the weight of the respective layer of colouring coating, in each layer.

21. The process according to claim 18, wherein the application of the colouring coating is carried out by means of a spray process, roller-coating process, curtain-coating process, in-mould process or by an electrostatic application process.

22. The process according to claim 21, wherein the application of the colouring coating is carried out as a spray process in two to four part-steps by applying two to four layers successively and in each case one on top of the other, where the amount of flake-form effect pigments having absorbent properties in each of the layers is at least 5% by weight, based on the dry weight of the respective layer, and where drying is carried out at a temperature of at least 20° C. after application of each layer.

23. The process according to claim 18, wherein at least one of the layers of the colouring coating has a dry layer thickness of <5 μm.

24. The process according to claim 18, wherein the surface of the plastic part is precoated with a primer layer and/or filler layer and/or electrostatically pretreated.

25. The process according to claim 18, wherein a clear coat is applied as outermost layer to the surface of the colouring coating.

26. The process according to claim 18, wherein the plastic part is a plastic plate or film, where the plastic part can optionally have a three-dimensional outer shape.

27. (canceled)

28. A vehicle part comprising a radar-compatible plastic part according to claim 1.
